(19) United States
(12) Patent Application Publication
(10) Pub. No.: US 2024/0201044 A1
(43) Pub. Date: Jun. 20, 2024

(54) ABNORMALITY DETECTION DEVICE, ABNORMALITY DETECTION SYSTEM, ABNORMALITY DETECTION METHOD, AND COMPUTER READABLE MEDIUM

(71) Applicant: DENSO CORPORATION, Kariya-city (JP)

(72) Inventors: TAKESHI MORINAGA, Kariya-city (JP); JUNKI KAWAGUCHI, Kariya-city (JP); YUJI KOYAMA, Kariya-city (JP); TETSUTO KAWAI, Kariya-city (JP)

(21) Appl. No.: 18/596,751

(22) Filed: Mar. 6, 2024

Related U.S. Application Data
(63) Continuation of application No. PCT/JP2022/031894, filed on Aug. 24, 2022.

(30) Foreign Application Priority Data
Dec. 24, 2021 (JP) 2021-211046
Aug. 3, 2022 (JP) 2022-124209

(51) Int. Cl. G01M 7/02; G01B 11/24

(52) U.S. Cl. CPC G01M 7/025; G01B 11/24

(57) ABSTRACT

An abnormality detection system acquires a frequency component of sound generated by cutting by a cutting machine. A calculation section calculates a value obtained by smoothing a value related to an intensity corresponding to a frequency in a predetermined range including a frequency at which wear occurs due to working of the machine in the frequency component. The abnormality detection device determines that the tool is abnormal when the smoothed value is outside the range between the damage threshold and the wear threshold.

### CROSS REFERENCE TO RELATED APPLICATIONS

This application is a continuation application of International Patent Application No. PCT/JP2022/031894 filed on Aug. 24, 2022, which designated the U.S. and based on and claims the benefits of priority of Japanese Patent Application No. 2021-211046 filed on Dec. 24, 2021 and Japanese Patent Application No. 2022-124209 filed on Aug. 3, 2022. The entire disclosure of all of the above applications is incorporated herein by reference.

### TECHNICAL FIELD

The present disclosure relates to an abnormality detection device, an abnormality detection system, an abnormality detection method, and a computer readable medium storing an abnormality detection program.

### BACKGROUND

Conventionally, a machine tool is known that includes a working chamber and a microphone that collects sounds within the working chamber.

### SUMMARY

An object of the present disclosure is to provide an abnormality detection device, an abnormality detection system, an abnormality detection method, and a computer readable medium that suppress incorrect determination of an abnormality.

According to one aspect of the present disclosure, an abnormality detection device includes
an analysis section that acquires a frequency component of physical quantity generated by working by a machine,
a calculation section that calculates a value obtained by smoothing a value related to an intensity corresponding to a frequency in a predetermined range including a frequency at which wear occurs due to working of the machine in the frequency component, and
a determination section that determines that the machine is abnormal when the value smoothed by the calculation section is outside a range between a damage threshold and a wear threshold.

Further, according to one aspect of the present disclosure, an abnormality detection system includes
a sensor that detects a physical quantity generated by working by a machine, and
an abnormality detection device having
   an analysis section that acquires a frequency component of the physical quantity,
   a calculation section that calculates a value obtained by smoothing a value related to an intensity corresponding to a frequency in a predetermined range including a frequency at which wear occurs due to working of the machine in the frequency component, and
   a determination section that determines that the machine is abnormal when the value smoothed by the calculation section is outside a range between a damage threshold and a wear threshold.

Further, according to one aspect of the present disclosure, a method for detecting an abnormality includes
acquiring a frequency component of physical quantity generated by working by a machine,
calculating a value obtained by smoothing a value related to an intensity corresponding to a frequency in a predetermined range including a frequency at which wear occurs due to working of the machine in the frequency component; and
determining that the machine is abnormal when the smoothed value is outside a range between a damage threshold and a wear threshold.

Further, according to one aspect of the present disclosure, a computer readable medium including an abnormality detection program configured to cause an abnormality detection device to function as
an analysis section that acquires a frequency component of physical quantity generated by working by a machine,
a calculation section that calculates a value obtained by smoothing a value related to an intensity corresponding to a frequency in a predetermined range including a frequency at which wear occurs due to working of the machine in the frequency component, and
a determination section that determines that the machine is abnormal when the value smoothed by the calculation section is outside a range between a damage threshold and a wear threshold.

### BRIEF DESCRIPTION OF DRAWINGS

FIG. 1 is a configuration diagram of an abnormality detection system according to a first embodiment;

FIG. 2 is a flowchart showing a processing of a abnormality detection device of the abnormality detection system of the first and fourth embodiments;

FIG. 3 is a diagram showing a relationship between intensity and time corresponding to an electrical signal of a sensor of the abnormality detection system;

FIG. 4 is a diagram showing a frequency characteristics acquired by the abnormality detection device;

FIG. 5 is an enlarged view of a part V in FIG. 4;

FIG. 6 is a diagram showing a relationship between frequency characteristics and amount of wear;

FIG. 7 is a diagram showing a relationship between smoothed values and time;

FIG. 8 is a diagram showing drilling by a cutting machine;

FIG. 9A is a diagram showing a relationship between time and smoothed value, FIG. 9B is a relationship between time and differences, and FIG. 90 is a relationship between time and a sum of the differences;

FIG. 10 is a flowchart showing a processing of the abnormality detection device of the abnormality detection system according to a second embodiment;

FIG. 11 is a diagram showing a frequency characteristics of environmental sound of a cutting machine in the abnormality detection system;

FIG. 12 is a flowchart showing a processing of the abnormality detection device of the abnormality detection system according to a third embodiment;

FIG. 13 is a flowchart showing a processing of the abnormality detection device of the abnormality detection system according to a fourth embodiment;

FIG. 14 is a flowchart showing a processing of the abnormality detection device of the abnormality detection system according to a sixth embodiment;

FIG. 15 is a configuration diagram of an abnormality detection system according to a seventh embodiment;

FIG. 16 is a flowchart showing a processing of the abnormality detection device of the abnormality detection system;

FIG. 17 is a configuration diagram of an abnormality detection system according to an eighth embodiment;

FIG. 18 is a configuration diagram of an abnormality detection system according to a ninth embodiment;

FIG. 19 is a flowchart showing a processing of the abnormality detection device of the abnormality detection system; and

FIG. 20 is a diagram showing a relationship between smoothed values and time by the abnormality detection device of the abnormality detection system of another embodiment.

### DETAILED DESCRIPTION

In an assumable example, a machine tool is known that includes a working chamber and a microphone that collects sounds within the working chamber. In this machine tool, a steady-state sound during operation of the machine tool is removed from the sound collected by the microphone, and the remaining sound is extracted. Then, when a signal level of the extracted sound is outside a specified range, this result is notified.

According to a discloser's study, the sound collected by the microphone includes not only steady-state sound during operation of the machine tool, but also noise from external sounds around the machine tool and electronic components installed in the machine tool. Due to this noise, in the machine tool described above, the signal level of the extracted sound falls outside the specified range, and the machine tool is incorrectly determined to be abnormal. An object of the present disclosure is to provide an abnormality detection device, an abnormality detection system, an abnormality detection method, and a computer readable medium that suppress incorrect determination of an abnormality.

According to one aspect of the present disclosure, an abnormality detection device includes
an analysis section that acquires a frequency component of physical quantity generated by working by a machine,
a calculation section that calculates a value obtained by smoothing a value related to an intensity corresponding to a frequency in a predetermined range including a frequency at which wear occurs due to working of the machine in the frequency component, and
a determination section that determines that the machine is abnormal when the value smoothed by the calculation section is outside a range between a damage threshold and a wear threshold.

Further, according to one aspect of the present disclosure, an abnormality detection system includes
a sensor that detects a physical quantity generated by working by a machine, and
an abnormality detection device having
   an analysis section that acquires a frequency component of the physical quantity,
   a calculation section that calculates a value obtained by smoothing a value related to an intensity corresponding to a frequency in a predetermined range including a frequency at which wear occurs due to working of the machine in the frequency component, and
   a determination section that determines that the machine is abnormal when the value smoothed by the calculation section is outside a range between a damage threshold and a wear threshold.

Further, according to one aspect of the present disclosure, a method for detecting an abnormality includes
acquiring a frequency component of physical quantity generated by working by a machine,
calculating a value obtained by smoothing a value related to an intensity corresponding to a frequency in a predetermined range including a frequency at which wear occurs due to working of the machine in the frequency component; and
determining that the machine is abnormal when the smoothed value is outside a range between a damage threshold and a wear threshold.

Further, according to one aspect of the present disclosure, a computer readable medium including an abnormality detection program configured to cause an abnormality detection device to function as
an analysis section that acquires a frequency component of physical quantity generated by working by a machine,
a calculation section that calculates a value obtained by smoothing a value related to an intensity corresponding to a frequency in a predetermined range including a frequency at which wear occurs due to working of the machine in the frequency component, and
a determination section that determines that the machine is abnormal when the value smoothed by the calculation section is outside a range between a damage threshold and a wear threshold.

As a result, a value related to the intensity corresponding to the frequency in the predetermined range is smoothed, so that a noise becomes smaller compared to a case where no smoothing is performed. Therefore, it is suppressed that a value related to intensity corresponding to a frequency in a predetermined range is incorrectly determined to be outside the range between the damage threshold and the wear threshold due to noise. Therefore, the incorrect determination of abnormality in the machine is suppressed.

Hereinafter, embodiments will be described with reference to the drawings. In the following embodiments, the same or equivalent parts are denoted by the same reference numerals as each other, and explanations will be provided to the same reference numerals.

### First Embodiment

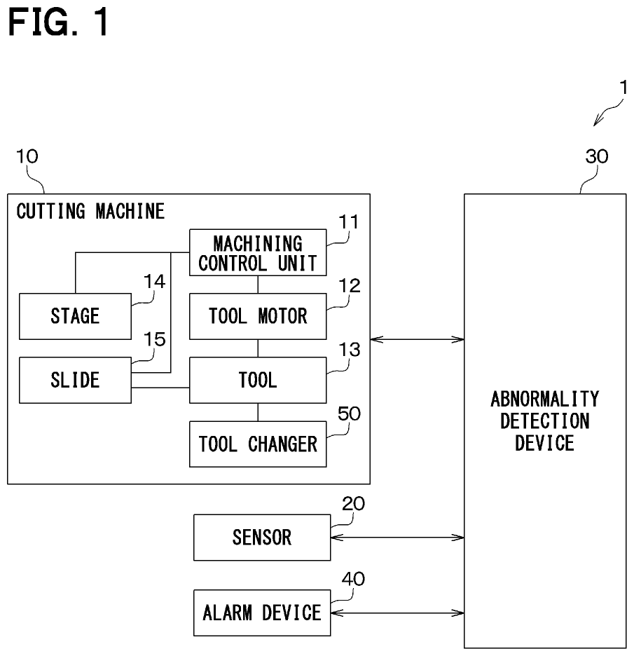

An abnormality detection system 1 of the present embodiment detects an abnormality due to wear or breakage of a tool 13 of a cutting machine 10. Specifically, the abnormality detection system 1 includes the cutting machine 10, a sensor 20, an abnormality detection device 30, and an alarm device 40, as shown in FIG. 1.

The cutting machine 10 cuts a workpiece 60. Specifically, the cutting machine 10 includes a machining control unit 11, a tool motor 12, a tool 13, a stage 14, a slide 15, and a tool changer 50.

The machining control unit 11 is mainly composed of a computer and includes a CPU, a ROM, a flash memory, a RAM, an I/O, a drive circuit, a bus line connecting these configurations, and the like. Furthermore, by executing a program stored in the ROM of the machining control unit 11, the machining control unit 11 controls the current flowing to the tool motor 12, the stage 14, and the slide 15, which will be described later, based on a signal from the abnormality detection device 30. Furthermore, the machining control unit 11 causes the controlled current to flow to the tool motor 12, the stage 14, and the slide 15, which will be described later.

The tool motor 12 is rotated by current controlled by the machining control unit 11. The tool 13 is a drill and rotates together with the tool motor 12.

The stage 14 moves the workpiece 60 placed on a stage plate (not shown) in one direction perpendicular to an axis of the tool 13 and in a direction perpendicular to the one direction. Specifically, the stage 14 includes a stage plate, a first motor for the stage, a first ball screw for the stage, a first rail for the stage, and a first block for the stage, which are not shown. The stage 14 also includes a second motor for the stage, a second ball screw for the stage, a second rail for the stage, and a second block for the stage (not shown).

The stage plate is perpendicular to the axis of the tool 13. The first ball screw for the stage and the first rail for the extend in one direction perpendicular to the axis of the tool 13. The first block for the stage is attached to the first ball screw for the stage and the first rail for the stage, and the stage plate is attached to the first block for the stage. The first motor for the stage is rotated by current controlled by the machining control unit 11. When the first motor for the stage rotates, the first ball screw for the stage rotates together with the first motor for the stage, so that the first block for the motor moves in one direction perpendicular to the axis of the tool 13 along the first rail for the stage. Thereby, the stage plate moves in one direction perpendicular to the axis of the tool 13 together with the first block for the stage. Therefore, the workpiece 60 placed on the stage plate moves in one direction perpendicular to the axis of the tool 13. Further, the second ball screw for the stage and the second rail for the stage extend in a direction perpendicular to the one direction. The second block for the stage is attached to the second ball screw for the stage and the second rail for the stage, and the stage plate is attached to the second block for the stage. The second motor for the stage is rotated by current controlled by the machining control unit 11. When the second motor for the stage rotates, the second ball screw for the stage rotates together with the second motor for the stage, so that the second block for the motor moves in a direction perpendicular to the above one direction along the second rail for the stage. Thereby, the stage plate moves in a direction perpendicular to the above one direction together with the second block for the stage. Therefore, the workpiece 60 placed on the stage plate moves in a direction perpendicular to the above one direction.

The slide 15 moves the tool 13 in an axial direction. Specifically, the slide 15 includes a slide motor, a slide ball screw, a slide rail, and a slide block (not shown).

The slide ball screw and the slide rail extend in the axial direction of the tool 13. The slide block is attached to the slide ball screw and the slide rail, and the tool 13 is attached to this slide block. The slide motor is rotated by current controlled by the machining control unit 11. When the slide motor rotates, the slide ball screw rotates together with the slide motor, so that the slide block moves in the axial direction of the tool 13 along the slide rail. Thereby, the tool 13 moves in the axial direction of the tool 13 together with the slide block.

The tool changer 50 is an ATC (Automatic Tool Changer) and exchanges a worn or damaged tool 13 with a new tool 13 in response to a signal from an abnormality detection device 30, which will be described later.

The sensor 20 has a microphone and converts the sound generated when the workpiece 60 is cut by the cutting machine 10 into an electrical signal. Furthermore, the sensor 20 outputs this converted electrical signal to the abnormality detection device 30, which will be described later. The microphone may be a moving coil type, a ribbon type, a condenser type, a carbon microphone, a piezoelectric microphone, a laser microphone, or the like.

Moreover, the sensor 20 has a resolver, an encoder, and the like, and detects a rotation speed of the tool 13 by detecting a rotation speed of the tool motor 12. Further, the sensor 20 outputs a signal corresponding to the detected rotation speed of the tool 13 to the abnormality detection device 30, which will be described later.

The abnormality detection device 30 is mainly composed of a computer and includes a CPU, a ROM, a flash memory, a RAM, an I/O, a drive circuit, a bus line connecting these configurations, and the like. Further, the abnormality detection device 30 executes a program stored in the ROM of the abnormality detection device 30, and based on the electrical signal from the sensor 20, outputs a signal indicating an abnormality of the tool 13 of the cutting machine 10 to the alarm device 40, which will be described later. Further, the abnormality detection device 30 causes the tool changer 50 to change the tool 13 based on the electrical signal from the sensor 20 by executing a program stored in the ROM of the abnormality detection device 30.

The alarm device 40 notifies an operator of the cutting machine 10 of an abnormality in the tool 13 using, for example, sound and light in response to the signal from the abnormality detection device 30.

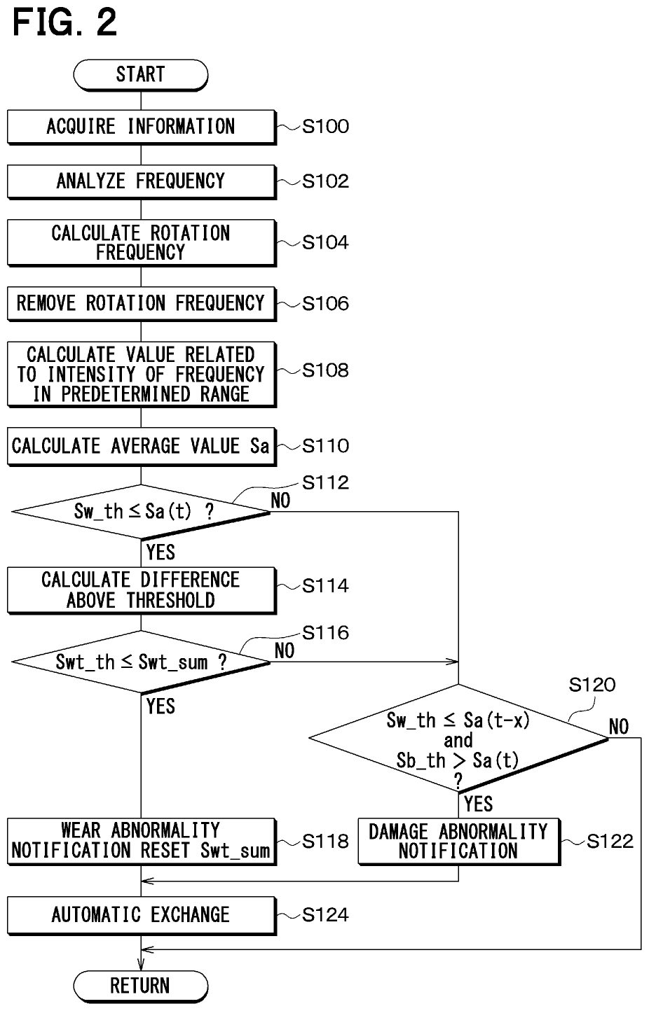

As described above, the abnormality detection system 1 of the first embodiment is configured. The abnormality detection device 30 of the abnormality detection system 1 detects an abnormality due to wear or damage of the tool 13. Next, this abnormality detection will be explained with reference to the flowchart of FIG. 2 and FIGS. 3 to 9. The program of the abnormality detection device 30 is executed, for example, when the power (not shown) of the cutting machine 10 is turned on. In addition, hereinafter, a period of a series of operations from a start of the processing of step S100 of the abnormality detection device 30 until a return to the processing of step S100 will be referred to as a control cycle T of the abnormality detection device 30.

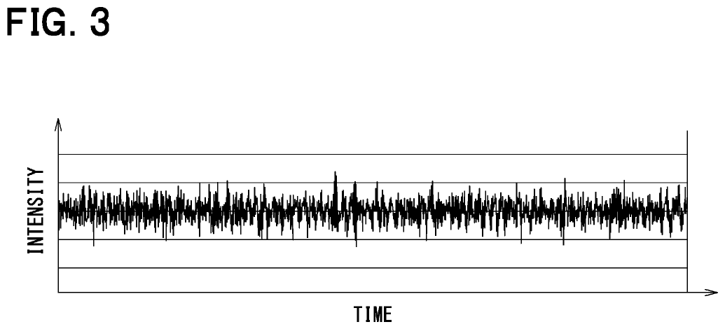

In step S100, the abnormality detection device 30 acquires the rotation speed of the tool 13 from the sensor 20. Further, the abnormality detection device 30 acquires from the sensor 20 an electric signal corresponding to the sound generated when the workpiece 60 is cut by the cutting machine 10 as shown in FIG. 3. Furthermore, the abnormality detection device 30 extracts this time waveform for a time section of a predetermined length. In addition, in FIG. 3, the electric signal corresponding to the sound generated when the workpiece 60 is cut by the cutting machine 10 is shown in terms of intensity.

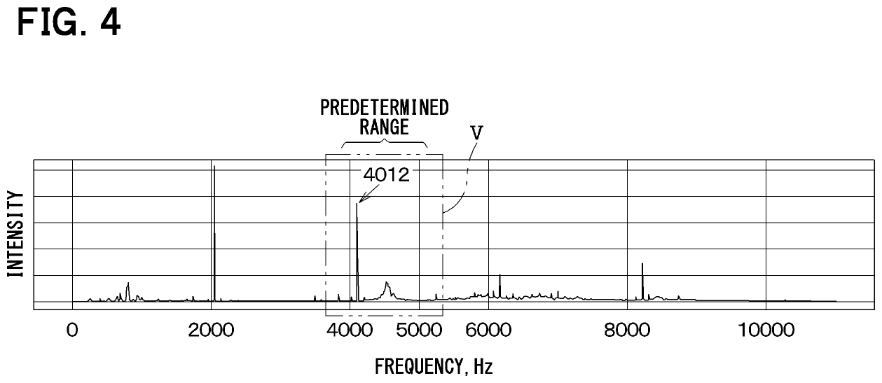

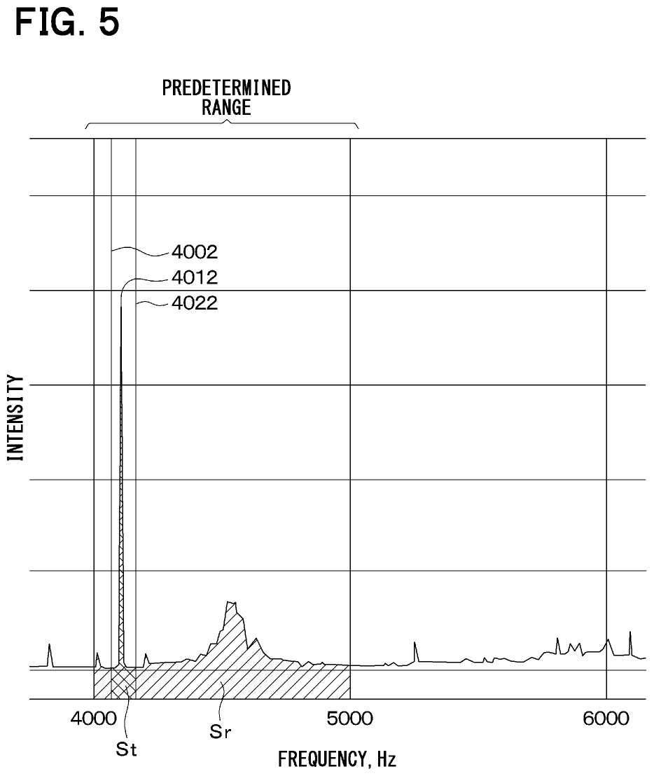

Subsequently, in step S102, the abnormality detection device 30 performs short-time Fourier transform on an intensity component of the time waveform acquired in step S100. Thereby, the abnormality detection device 30 acquires the frequency characteristic indicating the relationship between the frequency and intensity of the electrical signal from the sensor 20 acquired in step S100, as shown in FIGS. 4 and 5. Further, the abnormality detection device 30 calculates an area Sr surrounded by a line indicating the relationship between the frequency in the predetermined range of the acquired frequency characteristic and its intensity. This frequency characteristic is a waveform in the frequency domain, and is data in which intensity values are assigned to each of a plurality of frequency bins within a predetermined frequency interval. Further, in FIG. 5, a range of the area Sr is indicated by diagonal hatching.

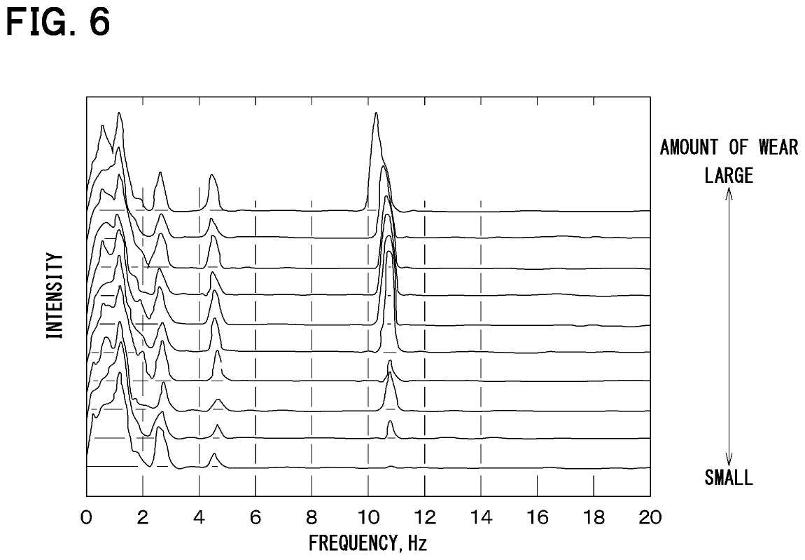

Here, the predetermined range is a range that includes the frequency of sound when the tool 13 is worn when the workpiece 60 is cut by the cutting machine 10. Specifically, as shown in FIG. 6, as the amount of wear increases, in a range of 3.0 to 12.0 kHz, a difference between the intensity baseline and peak value increases in the 1.0 KHz to 2.0 kHz section, for example, in the 4.0 to 5.0 kHz section, in the 10.0 to 12.0 KHz section. Therefore, in order to detect the wear state of the tool 13, the predetermined range is a section of 1.0 KHz to 2.0 KHz within the range of 3.0 to 12.0 KHz. Here, the predetermined range is, for example, the section of 4.0 kHz to 5.0 KHz.

Returning to FIG. 2, in step S104 following step S102, the abnormality detection device 30 calculates the frequency of the tool 13 from the rotation speed of the tool 13 acquired in step S100. Further, the abnormality detection device 30 determines whether the multiple of the calculated frequency of the tool 13 is within the predetermined range. When this multiple is within the predetermined range, the abnormality detection device 30 calculates the multiple as the rotation frequency of the tool 13. Here, the rotation frequency of the tool 13 is, for example, 4.012 KHz.

Subsequently, in step S106, the abnormality detection device 30 calculates a predetermined frequency band centered on the rotation frequency of the tool 13 calculated in step S104, for example, a frequency band of 4.002 to 4.022 kHz. Further, as shown in FIG. 6, the abnormality detection device 30 calculates an area St surrounded by a line indicating the relationship between the calculated predetermined frequency band and its intensity. Further, the abnormality detection device 30 subtracts the calculated area St from the area Sr calculated in step S102. Thereby, the abnormality detection device 30 calculates a subtraction value. Therefore, noise caused by the rotation of the tool 13 is removed from the frequency characteristic corresponding to the electrical signal of the sensor 20 acquired in step S102. In addition, in FIG. 6, the range of area St is shown by hatching.

Subsequently, in step S108, the abnormality detection device 30 calculates an average value Ss by dividing the subtraction value calculated in step S106 by an interval within a predetermined range. Thereby, the abnormality detection device 30 calculates a value related to the intensity corresponding to a unit frequency in a predetermined range among the frequency components.

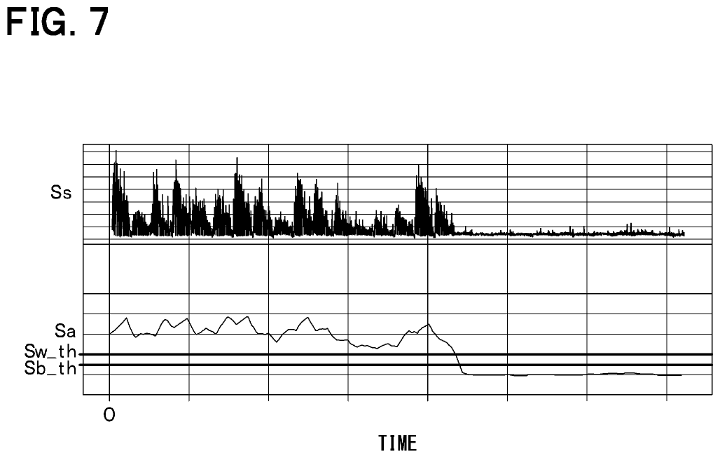

Subsequently, in step S110, the abnormality detection device 30 calculates a smoothed value Sa with respect to time using the average value Ss calculated in step S108. As a result, as shown in FIG. 7, the average value Ss is smoothed over time, so that the noise included in the smoothed value Sa is smaller than the noise included in the average value Ss. Here, smoothing refers to creating an approximation function that extracts important features of data while eliminating noise and other fine structures or abrupt phenomena in statistics and signal processing. The smoothing is performed using, for example, a simple moving average, a weighted moving average, an exponential moving average, a triangular moving average, a sinusoidal weighted moving average, a cumulative moving average, or the like. Further, the smoothing may be performed using convolution, a KZ filter, an envelope, a moving standard deviation, and the like. The smoothing may be performed using a filter such as an averaging filter, a Gaussian filter, a median filter, a maximum value filter, and a minimum value filter.

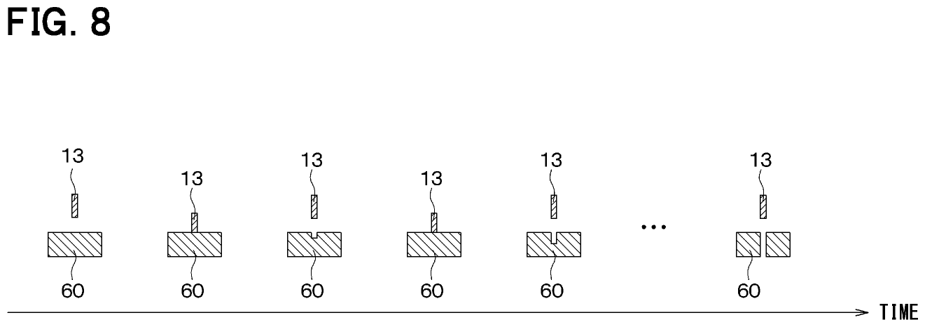

Here, as the tool 13 is rotated by the tool motor 12 and moved in the axial direction by the slide 15, the workpiece 60 is drilled multiple times for one hole, as shown in FIG. 8. Therefore, in FIG. 7, a peak value of the smoothed value Sa is generated at the initial stage of cutting one hole. Further, after the initial cutting of one hole, the smoothed value Sa decreases from the peak value as time passes. Furthermore, since the workpiece 60 is drilled with a plurality of holes, a plurality of peak values of the smoothed value Sa are generated as time passes.

Returning to FIG. 2, in step S112 following step S110, the abnormality detection device 30 determines whether the smoothed value Sa in the current control cycle (t) calculated in step S110 is greater than or equal to the wear threshold value Sw_th. Thereby, the abnormality detection device 30 determines whether there is a high possibility that the cutting accuracy has decreased due to wear of the tool 13. The wear threshold value Sw_th is set by experiment, simulation, etc. so that a possibility of a decrease in cutting accuracy due to wear of the tool 13 is determined by the abnormality detection device 30. Further, t is an integer greater than or equal to 0, and indicates the number of times the abnormality detection device 30 executes a series of processing from step S100. Further, the smoothed value Sa at the control cycle τ(0) is, for example, 0. Further, in the flowchart of FIG. 2, the smoothed value Sa in the current control cycle τ(t) is indicated by Sa(t).

When the smoothed value Sa is equal to or higher than the wear threshold value Sw_th, the intensity of the wear noise of the tool 13 is high, so the abnormality detection device 30 determines that there is a high possibility that the cutting accuracy has decreased due to the wear of the tool 13. Then, the processing of the abnormality detection device 30 moves to step S114. Moreover, when the smoothed value Sa is less than the wear threshold value Sw_th, the intensity of the wear noise of the tool 13 is lower than when the smoothed value Sa is equal to or greater than the wear threshold value Sw_th. Thereby, at this time, the abnormality detection device 30 determines that there is a low possibility that the cutting accuracy has decreased due to the wear of the tool 13. Thereafter, the processing of the abnormality detection device 30 moves to step S120.

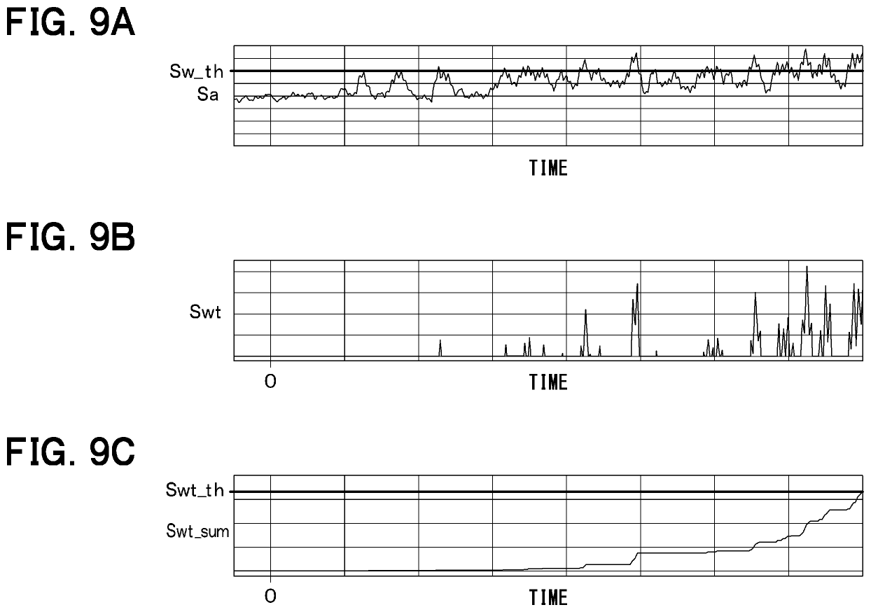

In step S114 following step S112, the abnormality detection device 30 subtracts the wear threshold value Sw_th from the smoothed value Sa calculated in step S110, as shown in FIGS. 9A to 9C. Thereby, the abnormality detection device 30 calculates the difference Swt that exceeds the wear threshold value Sw_th among the smoothed values Sa in the current control cycle τ(t). When the smoothed value Sa is less than the wear threshold value Sw_th, the difference Swt in the current control cycle τ(t) is 0. Furthermore, the difference Swt in the control cycle τ(0) is, for example, 0.

Further, the abnormality detection device 30 adds the calculated difference Swt in the current control cycle τ(t) to the difference sum Swt_sum in the previous control cycle τ(t−1). Thereby, the abnormality detection device 30 calculates the difference sum Swt_sum in the current control cycle τ(t). The difference sum Swt_sum in the control cycle τ(0) is, for example, 0.

Returning to FIG. 2, in step S116 following step S114, the abnormality detection device 30 determines whether the difference sum Swt_sum calculated in step S114 is greater than or equal to the sum threshold value Swt_th. Thereby, the abnormality detection device 30 determines whether the cutting accuracy has decreased due to the wear of the tool 13. The sum threshold value Swt_th is set through experiments, simulations, etc. so that the abnormality detection device 30 determines that the cutting accuracy has decreased due to the wear of the tool 13. Further, the sum threshold value Swt_th may be freely set by the user of the abnormality detection device 30.

When the difference sum Swt_sum is greater than or equal to the sum threshold value Swt_th, the intensity of the wear noise of the tool 13 does not momentarily increase, but the cutting accuracy has decreased due to the wear of the tool 13. Therefore, at this time, the abnormality detection device 30 determines that the cutting accuracy has decreased due to the wear of the tool 13. Thereafter, the processing of the abnormality detection device 30 moves to step S118. In addition, when the difference sum Swt_sum is less than the sum threshold value Swt_th, the intensity of the wear noise of the tool 13 increases momentarily, so the abnormality detection device 30 determines that the cutting accuracy has not deteriorated due to the wear of the tool 13. Thereafter, the processing of the abnormality detection device 30 moves to step S120.

In step S118 following step S116, the abnormality detection device 30 outputs a signal to the alarm device 40 indicating that cutting accuracy has decreased due to the wear of the tool 13. At this time, the alarm device 40 uses sound and light to notify the operator of the cutting machine 10 of an abnormality in the tool 13 of the cutting machine 10 due to a decrease in cutting accuracy due to the wear of the tool 13. Further, the abnormality detection device 30 resets the difference sum Swt_sum by setting the difference sum Swt_sum calculated in step S114 to 0. Thereafter, the processing of the abnormality detection device 30 moves to step S124.

In step S120, the abnormality detection device 30 determines whether the smoothed value Sa calculated in step S110 has changed from being equal to or greater than the wear threshold value Sw_th to less than a damage threshold value Sb_th. Thereby, the abnormality detection device 30 determines whether or not the tool 13 is damaged. The damage threshold Sb_th is set by experiment, simulation, etc. so that the abnormality detection device 30 determines whether the tool 13 is damaged. Furthermore, here, the damage threshold Sb_th is set to be smaller than the wear threshold Sw_th. Furthermore, the damage threshold Sb_th may be freely set by the user of the abnormality detection device 30.

Specifically, the abnormality detection device 30 determines that the smoothed value Sa in the past control cycle τ(t−x) is equal to or higher than the wear threshold Sw_th, and the smoothed value Sa in the current control cycle τ(t) is less than the damage threshold Sb_th. It is assumed that the smoothed value Sa in the past control cycle τ(t−x) is greater than or equal to the wear threshold Sw_th, and the smoothed value Sa in the current control cycle τ(t) is less than the damage threshold Sb_th. At this time, since the smoothed value Sa is decreasing, the noise generated by cutting by the cutting machine 10 is decreasing. Therefore, at this time, the abnormality detection device 30 determines that the tool 13 is damaged. Thereafter, the processing of the abnormality detection device 30 moves to step S122. The past control cycle τ(t−x) is a control cycle T earlier than the current control cycle τ(t). Furthermore, in the flowchart of FIG. 2, the smoothed value Sa in the past control cycle τ(t−x) is indicated by Sa(t−x). Further, x is an integer of 1 or more when t is an integer of 1 or more. Moreover, x is 0 when t is 0. Further, x is set by experiment, simulation, etc. so that the abnormality detection device 30 determines whether the tool 13 is damaged.

It is also assumed that the smoothed value Sa in the previous control cycle τ(t−1) is greater than or equal to the wear threshold Sw_th, and the smoothed value Sa in the current control cycle τ(t) is greater than or equal to the damage threshold Sb_th. At this time, since the change in the smoothed value Sa is small, the change in the sound generated by cutting by the cutting machine 10 is small. Therefore, at this time, the abnormality detection device 30 determines that the tool 13 is not damaged. Thereafter, the processing of the abnormality detection device 30 returns to step S100.

Furthermore, it is assumed that the smoothed value Sa in the previous control cycle τ(t−1) is less than the wear threshold Sw_th, and the smoothed value Sa in the current control cycle τ(t) is less than the damage threshold Sb_th. At this time, since the change in the smoothed value Sa is small, the change in the sound generated by cutting by the cutting machine 10 is small. Therefore, at this time, the abnormality detection device 30 determines that the tool 13 is not damaged. Thereafter, the processing of the abnormality detection device 30 returns to step S100.

Furthermore, it is assumed that the smoothed value Sa in the previous control cycle τ(t−1) is less than the wear threshold Sw_th, and the smoothed value Sa in the current control cycle τ(t) is greater than or equal to the damage threshold Sb_th. At this time, since the change in the smoothed value Sa is small, the change in the sound generated by cutting by the cutting machine 10 is small. Therefore, at this time, the abnormality detection device 30 determines that the tool 13 is not damaged. Therefore, at this time, the abnormality detection device 30 determines that the tool 13 is not damaged. Thereafter, the processing of the abnormality detection device 30 returns to step S100.

In step S122 following step S120, the abnormality detection device 30 outputs a signal indicating that the tool 13 is damaged to the alarm device 40. At this time, the alarm device 40 uses sound and light to notify the operator of the cutting machine 10 that the tool 13 is damaged. Thereafter, the processing of the abnormality detection device 30 moves to step S124.

In step S124, the abnormality detection device 30 outputs a signal to the tool changer 50 to cause the tool 13 to be replaced. Thereby, the tool changer 50 replaces the worn or damaged tool 13 with a new tool 13. Thereafter, the processing of the abnormality detection device 30 returns to step S100.

As described above, the abnormality detection device 30 detects the abnormality due to wear or damage of the tool 13. This abnormality detection device 30 suppresses the incorrect determination of abnormality due to wear or damage of the tool 13. Next, suppression of this incorrect determination will be explained.

The abnormality detection device 30 acquires the frequency component of the sound generated by cutting by the cutting machine 10 in step S102. Further, in step S108, the abnormality detection device 30 calculates a value related to the intensity, in this case, the average value Ss, corresponding to a frequency in a predetermined range including the frequency at which the tool 13 is worn out by cutting in the frequency component. Further, in step S110, the abnormality detection device 30 calculates the smoothed value Sa with respect to time in the average value Ss. Furthermore, in step S112, the abnormality detection device 30 determines that there is a high possibility that the cutting accuracy has decreased due to the wear of the tool 13 when the smoothed value Sa is equal to or greater than the wear threshold value Sw_th. Further, in step S120, the abnormality detection device 30 determines that the tool 13 is damaged when the smoothed value Sa changes from more than the damage threshold Sb_th to less than the damage threshold Sb_th. Therefore, the abnormality detection device 30 determines that the tool 13 is abnormal when the smoothed value Sa is outside the range between the damage threshold Sb_th and the wear threshold Sw_th. The abnormality detection device 30 corresponds to an analysis section, a calculation section, and a determination section. Furthermore, sound corresponds to a physical quantity. Furthermore, the average value Ss corresponds to a value related to the intensity corresponding to a predetermined range of frequencies among the frequency components.

Since the abnormality detection device 30 calculates the smoothed value Sa with respect to time in the average value Ss, the average value Ss with respect to time is smoothed. Therefore, the noise included in the value related to the smoothed value Sa is smaller than the noise included in the average value Ss. Therefore, the incorrect determination that the value related to the smoothed value Sa is outside the range between the damage threshold Sb_th and the wear threshold Sw_th due to noise is suppressed. Therefore, the incorrect determination of abnormality due to wear or damage of the tool 13 is suppressed.

Moreover, since this incorrect determination is suppressed, it is suppressed that the tool 13 is not incorrectly determined to be damaged even though the tool 13 is damaged. This prevents the tool 13 from being cut by the cutting machine 10 in a damaged state, thereby saving machining time. Therefore, since an overall equipment efficiency of the cutting machine 10 is improved, the productivity of the cutting machine 10 is improved.

Moreover, the abnormality detection device 30 also has the effects described below.

[1-1] Here, in a wear detection device described in Japanese Patent Publication No. 2002-59342, when a signal level of a frequency component in a predetermined range including a natural frequency of the cutting tool is equal to or higher than a preset setting value, the wear detection device determines that the cutting tool is worn out. However, in the above-mentioned wear detection device, due to noise caused by the natural frequency of the cutting tool, when the signal level of the extracted frequency component in a predetermined range exceeds a preset setting value, it is incorrectly determined that the cutting tool is abnormal.

In contrast, in step S106, the abnormality detection device 30 calculates a predetermined frequency band centered on the rotation frequency of the tool 13 calculated in step S104. Further, the abnormality detection device 30 calculates an area St surrounded by a line indicating the relationship between the calculated predetermined frequency band and its intensity. Further, the abnormality detection device 30 subtracts the calculated area St from the area Sr calculated in step S102. As a result, the value related to the intensity corresponding to the frequency in the predetermined range is a value obtained by subtracting the value related to the intensity corresponding to the frequency included in the predetermined range among the frequencies caused by the rotation of the tool 13 from the value related to the intensity corresponding to the frequency in the predetermined range. Therefore, since noise caused by the rotation of the tool 13 is removed, the noise included in the value related to the smoothed value Sa is reduced. Therefore, the incorrect determination that the value related to the smoothed value Sa is outside the range between the damage threshold Sb_th and the wear threshold Sw_th due to noise is suppressed. Therefore, the incorrect determination of abnormality due to wear or damage of the tool 13 is suppressed.

[1-2] It is assumed that the difference sum Swt_sum calculated in step S114 is greater than or equal to the sum threshold value Swt_th. At this time, the abnormality detection device 30 determines in step S116 that the abnormality is due to the wear of the tool 13, in this case, that the cutting accuracy has decreased due to the wear of the tool 13. Thereby, the abnormality detection device 30 can recognize the wear state of the tool 13. Therefore, the tool 13 can be used up until the cutting accuracy deteriorates due to the wear of the tool 13. Further, by using the difference sum Swt_sum, that is, the integrated value, it is possible to suppress the incorrect determination of the abnormality due to an instantaneous increase in the intensity of the wear noise of the tool 13. The difference sum Swt_sum corresponds to the integrated value of values related to intensity corresponding to frequencies in a predetermined range.

[1-3] The damage threshold Sb_th is smaller than the wear threshold Sw_th. Further, in step S120, the abnormality detection device 30 determines that the tool 13 is damaged when the value related to the smoothed value Sa calculated in step S110 changes from a state of being equal to or greater than the wear threshold value Sw_th to less than the damage threshold value Sb_th. Thereby, the abnormality detection device 30 can recognize damage to the tool 13.

[1-4] In step S118, the abnormality detection device 30 outputs a signal to the alarm device 40 indicating that the cutting accuracy has decreased due to the wear of the tool 13. At this time, the alarm device 40 uses sound and light to notify the operator of the cutting machine 10 of an abnormality in the tool 13 of the cutting machine 10 due to a decrease in cutting accuracy due to the wear of the tool 13. Further, the abnormality detection device 30 outputs a signal indicating that the tool 13 is damaged to the alarm device 40 in step S122. At this time, the alarm device 40 uses sound and light to notify the operator of the cutting machine 10 that the tool 13 is damaged. Therefore, the abnormality detection device 30 corresponds to a notification section, and when it is determined that the tool 13 is abnormal, it causes the alarm device 40 to notify that the tool 13 is abnormal. According to this configuration, an outside person, such as an operator of the cutting machine 10, can know that the tool 13 is abnormal.

[1-5] The abnormality detection device 30 corresponds to the exchange section, and in step S124, since the tool 13 is abnormal, the abnormality detection device 30 outputs a signal to the tool changer 50 to cause the tool 13 to be exchanged. At this time, the tool changer 50 replaces the worn or damaged tool 13 with a new tool 13. According to this configuration, by eliminating the need for replacement by a person such as an operator, the downtime of the cutting machine 10 is shortened, and the overall equipment efficiency of the cutting machine 10 is improved. Therefore, the productivity of the cutting machine 10 is improved.

### Second Embodiment

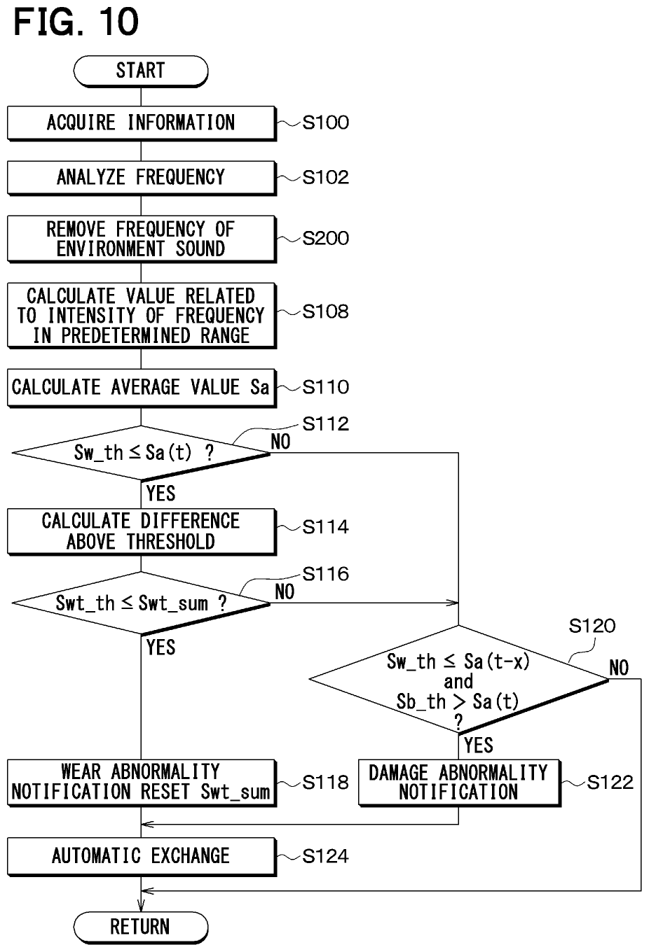

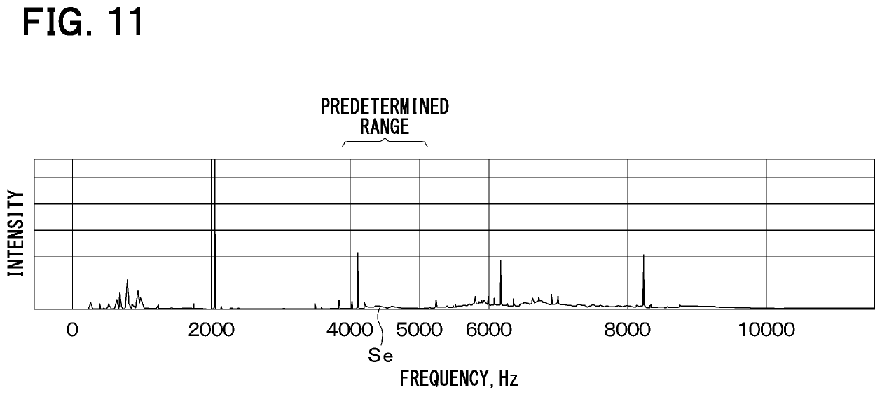

In the second embodiment, the processing of the abnormality detection device 30 is different. The other configurations are the same as those of the first embodiment. The processing of this abnormality detection device 30 will be explained with reference to the flowchart of FIG. 10 and FIG. 11.

In step S100, the abnormality detection device 30 acquires an electrical signal corresponding to the sound generated by the cutting machine 10 from the sensor 20, as in the first embodiment. Further, the abnormality detection device 30 extracts this time waveform for a time section of a predetermined length. Furthermore, the abnormality detection device 30 reads out the electrical signal corresponding to the environmental sound stored in the memory of the abnormality detection device 30 from the memory. The environmental sounds is sounds when the cutting machine 10 idles including sounds outside the cutting machine 10, sounds caused by the rotation of the tool 13 before cutting the workpiece 60 by the cutting machine 10, and air blow noise (not shown) of the cutting machine 10, etc. Furthermore, the abnormality detection device 30 is not limited to reading out the information about environmental sounds from memory. For example, the abnormality detection device 30 may acquire the environment sounds by separating the sound generated when the workpiece 60 is cut by the cutting machine 10 from the environmental sound by separating in time when the tool 13 is in contact with the workpiece 60 and when the tool 13 is not in contact with the work piece 60.

Subsequently, in step S102, the abnormality detection device 30 performs short-time Fourier transform on an intensity component of the time waveform acquired in step S100. Thereby, the abnormality detection device 30 acquires the frequency characteristic indicating the relationship between the frequency and intensity of the electrical signal from the sensor 20 acquired in step S100, similar to the first embodiment. Further, the abnormality detection device 30 calculates an area Sr surrounded by a line indicating the relationship between the frequency in the predetermined range of the acquired frequency characteristic and its intensity. Furthermore, as shown in FIG. 11, the abnormality detection device 30 obtains the frequency characteristics of the environmental sound read out in step S100 by performing short-time Fourier transform. Furthermore, the abnormality detection device 30 calculates an area Se surrounded by a line indicating the relationship between the frequency in the predetermined range and its intensity in the frequency characteristic of the acquired environmental sound.

Returning to FIG. 10, in step S200 following step S102, the abnormality detection device 30 subtracts the area Se from the area Sr acquired in step S102. Thereby, the abnormality detection device 30 calculates a subtraction value. Therefore, noise due to environmental sounds is removed from the frequency characteristic corresponding to the electrical signal of the sensor 20 acquired in step S102. Thereafter, the processings from step S108 to step S124 are performed in the same manner as in the first embodiment.

As described above, in the second embodiment, the processing of the abnormality detection device 30 is performed. The second embodiment achieves the effects described below.

[2] Here, in the abnormality sign detection system described in Japanese Patent No. 6712236, the time between adjacent intersections of the sensed acoustic waveform and the set sample line is integrated. When the ratio between the integrated value and the value during normal times is less than or equal to a predetermined value, it is determined that there is an abnormality sign in the working tool of the abnormality sign detection system. However, since the above-mentioned abnormality sign detection system does not take into account noise caused by environmental sounds, it is incorrectly determined that there is an abnormality sign in the machining tool when the ratio becomes less than the predetermined value due to noise caused by environmental sounds.

In contrast, in step S200, the abnormality detection device 30 subtracts the area Se from the area Sr acquired in step S102. Thereby, the value related to the intensity corresponding to the frequency in the predetermined range is a value obtained by subtracting the value related to the intensity included in the predetermined range among the frequencies of the environmental sound from the value related to the intensity corresponding to the frequency in the predetermined range. Therefore, since the noise caused by the environmental sound is removed, the noise included in the value related to the smoothed value Sa becomes smaller. Therefore, the incorrect determination that the value related to the smoothed value Sa is outside the range between the damage threshold Sb_th and the wear threshold Sw_th due to noise is suppressed. Therefore, the incorrect determination of abnormality due to wear or damage of the tool 13 is suppressed.

### Third Embodiment

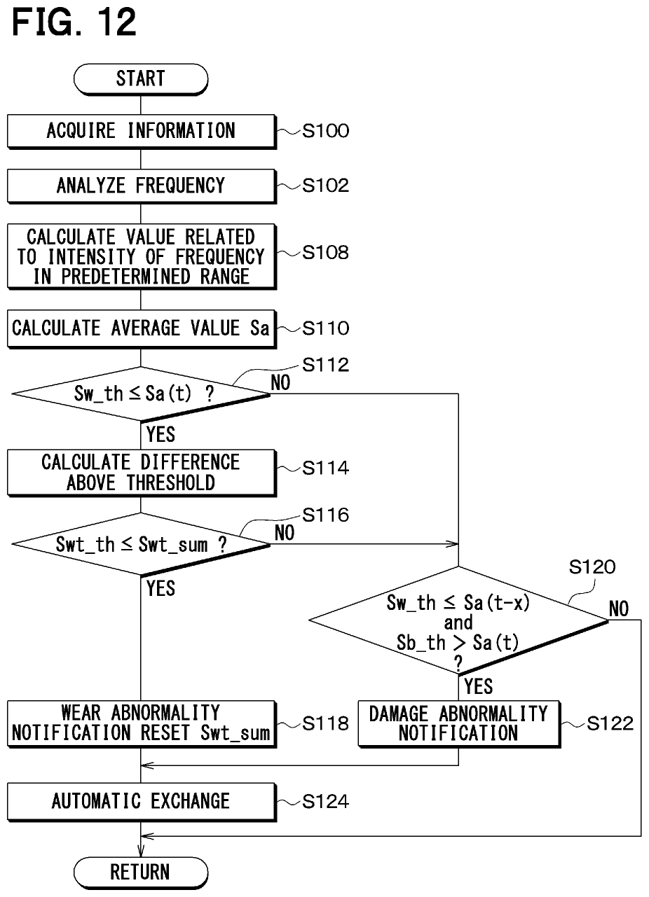

In the third embodiment, the processing of the abnormality detection device 30 is different. Other than this configuration, the third embodiment is the same as the first embodiment and the second embodiment. The processing of this abnormality detection device 30 will be explained with reference to the flowchart of FIG. 12.

In the third embodiment, after the processing in step S102, the abnormality detection device 30 performs the processing in step S108 without performing steps S104 and S106 in the first embodiment and step S200 in the second embodiment.

Specifically, in step S108, the abnormality detection device 30 calculates an average value Ss for the frequency in the area Sr calculated in step S102. This reduces noise regarding frequency.

Subsequently, in step S110, the abnormality detection device 30 calculates a smoothed value Sa with respect to time using the average value Ss calculated in step S108. As a result, the average value Ss is smoothed over time, so that the noise included in the smoothed value Sa is smaller than the noise included in the average value Ss. Thereafter, the processings from step S112 to step S124 are performed in the same manner as in the first embodiment. The third embodiment achieves effects similar to the effects achieved by the first embodiment.

### Fourth Embodiment

In the fourth embodiment, the processing in step S104 of the abnormality detection device 30 is different from the first embodiment. The other configurations are the same as those of the first embodiment.

As shown in FIG. 2, in step S104 following step S102, the abnormality detection device 30 calculates the rotation frequency of the tool 13. Further, here, instead of calculating the frequency of the tool 13 from the rotation speed of the tool 13 acquired in step S100, the abnormality detection device 30 calculates the rotation frequency of the tool 13 from the frequency characteristic acquired in step S102.

Here, the strength corresponding to the rotation frequency of the tool 13 is larger than the peak value of the strength related to wear, as shown in FIG. 6. Therefore, the abnormality detection device 30 calculates the peak value of the intensity related to wear from the frequency characteristics acquired in step S102 using machine learning or the like that detects the peak value based on the teacher data. Further, the abnormality detection device 30 detects a peak value larger than the calculated peak value of the intensity related to wear. Furthermore, the abnormality detection device 30 calculates a predetermined frequency band centered on the frequency of the detected peak value, here, the frequency band of 4.002 to 4.022 kHz, as the rotation frequency of the tool 13. The abnormality detection device 30 is not limited to calculating the rotation frequency of the tool 13 using the above-described statistical method. For example, the abnormality detection device 30 may calculate the rotation frequency of the tool 13 using machine learning or the like that detects a peak value based on teacher data.

As described above, the abnormality detection device 30 of the fourth embodiment performs the processings. The fourth embodiment achieves effects similar to the effects achieved by the first embodiment. Furthermore, the fourth embodiment also achieves the effects described below.

[3] In step S104, the abnormality detection device 30 calculates a peak value that is larger than the peak value related to wear included in the frequency in the predetermined range. According to this configuration, the rotation frequency of the tool 13 is easier to calculate than when calculated experimentally.

### Fifth Embodiment

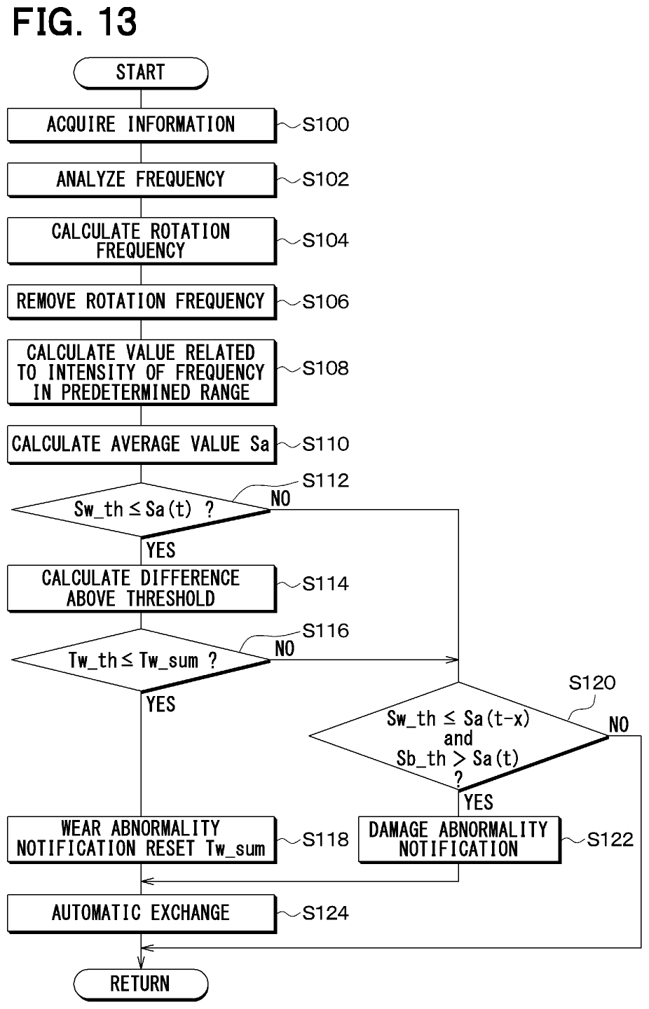

In the fifth embodiment, the processings of step S114, step S116, and step S118 of the abnormality detection device 30 are different from the first embodiment. The other configurations are the same as those of the first embodiment. Next, the processings in steps S114, S116, and S118 will be described with reference to the flowchart in FIG. 13.

In step S114 following step S112, the abnormality detection device 30 calculates the time sum Tw_sum when the smoothed value Sa calculated in step S110 is equal to or greater than the wear threshold value Sw_th. For example, when the smoothed value Sa is equal to or greater than the wear threshold value Sw_th, the abnormality detection device 30 adds the control period T to the time sum Tw_sum in the previous control period τ(t−1). Thereby, the abnormality detection device 30 calculates the time sum Tw_sum in the current control cycle τ(t). The time sum Tw_sum in the control period τ(0) is, for example, 0.

In step S116 following step S114, the abnormality detection device 30 determines whether the time sum Tw_sum calculated in step S114 is greater than or equal to the time threshold Tw_th. Thereby, the abnormality detection device 30 determines whether the cutting accuracy has decreased due to the wear of the tool 13. The time threshold Tw_th is set through experiments, simulations, etc. so that the abnormality detection device 30 determines that the cutting accuracy has decreased due to the wear of the tool 13. Further, the time threshold Tw_th may be freely set by the user of the abnormality detection device 30.

When the time sum Tw_sum is equal to or greater than the time threshold value Tw_th, the intensity of the wear noise of the tool 13 does not increase instantaneously, but the cutting accuracy decreases due to the wear of the tool 13. Therefore, at this time, the abnormality detection device 30 determines that the cutting accuracy has decreased due to the wear of the tool 13. Thereafter, the processing of the abnormality detection device 30 moves to step S118. Furthermore, when the time sum Tw_sum is less than the time threshold Tw_th, the intensity of the wear noise of the tool 13 increases instantaneously, so the abnormality detection device 30 determines that the cutting accuracy has not deteriorated due to the wear of the tool 13. Thereafter, the processing of the abnormality detection device 30 moves to step S120.

In step S118 following step S116, the abnormality detection device 30 outputs a signal to the alarm device 40 indicating that cutting accuracy has decreased due to the wear of the tool 13. At this time, the alarm device 40 uses sound and light to notify the operator of the cutting machine 10 of an abnormality in the tool 13 of the cutting machine 10 due to a decrease in cutting accuracy due to the wear of the tool 13. Further, the abnormality detection device 30 resets the time sum Tw_sum by setting the time sum Tw_sum calculated in step S114 to 0. Thereafter, the processing of the abnormality detection device 30 moves to step S124.

As described above, the abnormality detection device 30 of the fifth embodiment performs the processings. The fifth embodiment achieves effects similar to the effects achieved by the first embodiment.

### Sixth Embodiment

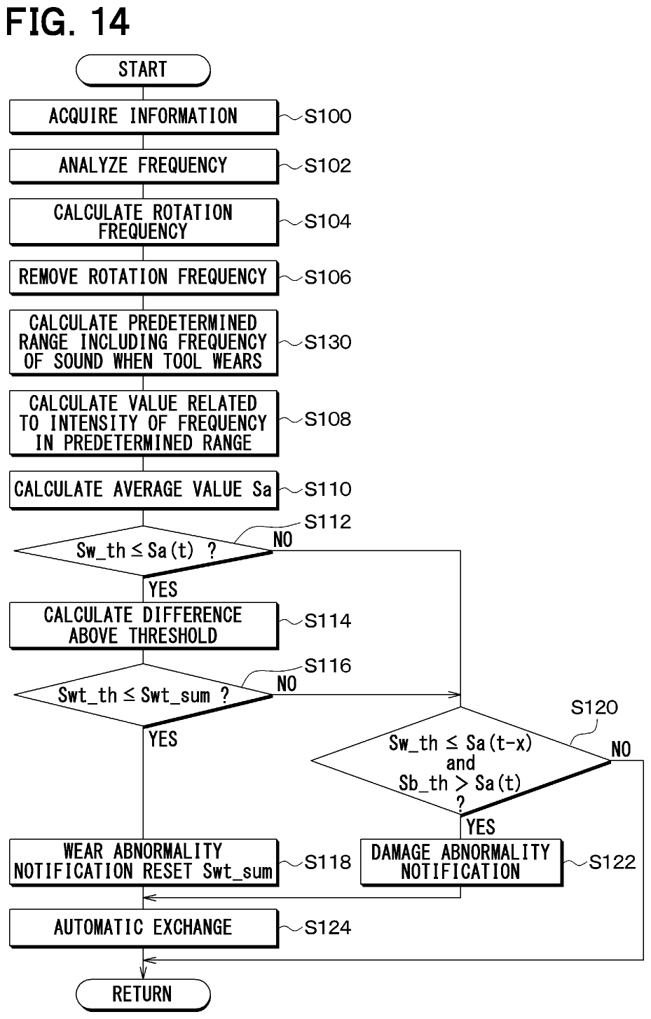

In the sixth embodiment, the processing of the abnormality detection device 30 is different from the first embodiment. The other configurations are the same as those of the first embodiment. Next, the processing of this abnormality detection device 30 will be explained with reference to the flowchart of FIG. 14.

In step S100, the abnormality detection device 30 acquires an electrical signal corresponding to the sound generated by the cutting machine 10 from the sensor 20, as in the first embodiment. Further, the abnormality detection device 30 extracts this time waveform for a time section of a predetermined length. Further, the abnormality detection device 30 reads information regarding the cutting machine 10, the tool 13, the sensor 20, and the workpiece 60 stored in the memory of the abnormality detection device 30 from the memory. The information regarding the cutting machine 10 includes, for example, the intensity and frequency of environmental sound, the intensity and frequency of sound caused by air blow (not shown) of the cutting machine 10, the temperature of the cutting machine 10, and an addition amount, a type, an addition cycle, etc. of oil used in the cutting machine 10. Further, the information regarding the tool 13 includes, for example, the size, material, shape, rotation speed, and torque of the tool 13, and an attachment state of the tool 13 and the cutting machine 10. Furthermore, the information regarding the sensor 20 includes, for example, a position of the sensor 20, a distance from the sensor 20 to the tool 13, a distance from the sensor 20 to the workpiece 60, a type and number of the sensors 20, and the like. Further, the information regarding the workpiece 60 includes, for example, the size, material, and shape of the workpiece 60, a contact angle between the workpiece 60 and the tool 13, and the like. Furthermore, the information regarding the cutting machine 10, tool 13, sensor 20, and workpiece 60 is freely set by the user of the abnormality detection device 30 and updated in the memory.

Subsequently, in step S102, step S104, and step S106, the abnormality detection device 30 performs the same processings as in the first embodiment.

In step S130 following step S106, the abnormality detection device 30 uses the information and map regarding the cutting machine 10, tool 13, sensor 20, and workpiece 60 acquired in step S100. Thereby, the abnormality detection device 30 calculates a frequency in a predetermined range that includes the frequency of sound when the tool 13 is worn when the workpiece 60 is cut by the cutting machine 10. The map for calculating frequencies in a predetermined range is set through experiments, simulations, and the like.

In step S108 following step S130, the abnormality detection device 30 calculates a value related to the intensity of the frequency in the predetermined range calculated in step S130, here, the average value Ss. Subsequently, in steps S110 to S124, the abnormality detection device 30 performs the same processings as in the first embodiment.

As described above, the abnormality detection device 30 of the sixth embodiment performs the processings. The sixth embodiment achieves effects similar to the effects achieved by the first embodiment. Furthermore, the sixth embodiment also achieves the effects described below.

[4] In step S130, the abnormality detection device 30 calculates the frequency in the predetermined range including the frequency of sound when the tool 13 wears out, based on information regarding the cutting machine 10, the tool 13, the sensor 20, and the workpiece 60. This makes it easier to adjust the settings of the predetermined range, which varies depending on the cutting machine 10, the tool 13, the sensor 20, and the workpiece 60.

### Seventh Embodiment

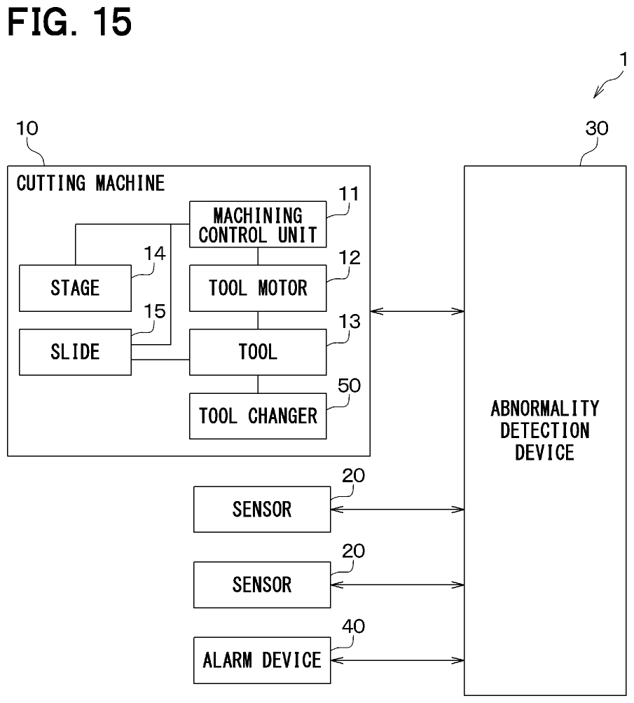

In the seventh embodiment, as shown in FIG. 15, two sensors 20 of the abnormality detection system 1 are provided. Further, the processings of the abnormality detection device 30 are different from the first embodiment. The other configurations are the same as those of the first embodiment.

One sensor 20 has a microphone and converts the sound generated when the workpiece 60 is cut by the cutting machine 10 into an electrical signal. Furthermore, another sensor 20 outputs this converted electrical signal to the abnormality detection device 30. Moreover, the other sensor 20 has a resolver, an encoder, and the like, and detects a rotation speed of the tool 13 by detecting a rotation speed of the tool motor 12. Further, the other sensor 20 outputs a signal corresponding to the detected rotation speed of the tool 13 to the abnormality detection device 30.

The other sensor 20 has a microphone to convert environmental sounds into electrical signals. Further, the other sensor 20 outputs this converted electrical signal to the abnormality detection device 30.

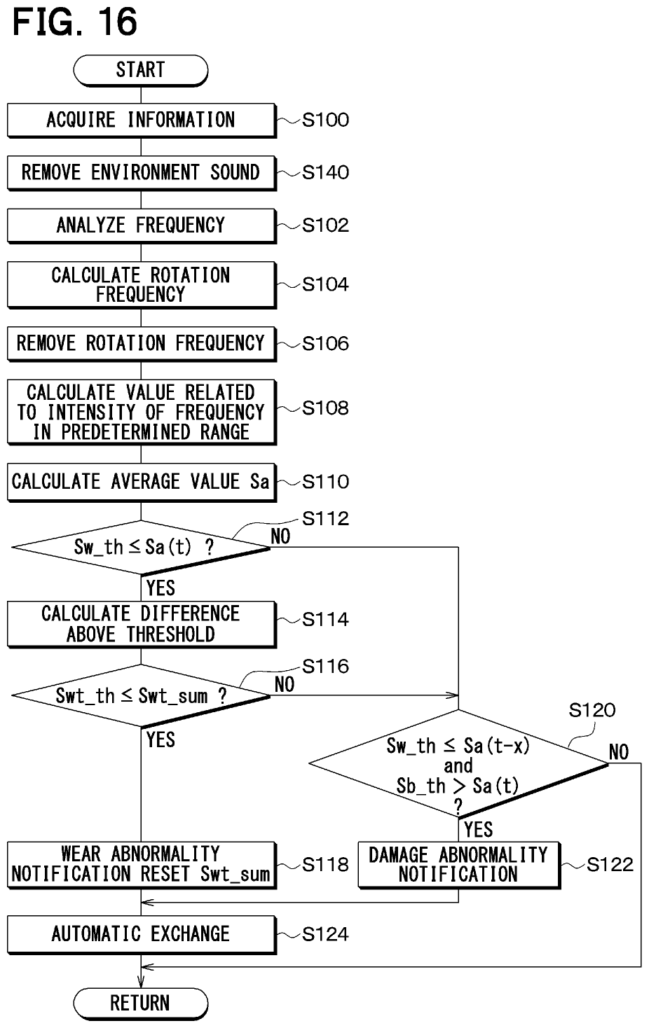

Next, the processing of the abnormality detection device 30 of the seventh embodiment will be described with reference to the flowchart of FIG. 16.

In step S100, the abnormality detection device 30 acquires the rotation speed of the tool 13 from one sensor 20. In addition to acquiring an electrical signal corresponding to the sound generated when the workpiece 60 is cut by the cutting machine 10 from one sensor 20, the abnormality detection device 30 also acquires an electrical signal corresponding to environmental sound from the other sensor 20. Further, the abnormality detection device 30 extracts these time waveforms for a time section of a predetermined length.

In S140 following step S100, the abnormality detection device 30 subtracts the intensity of the environmental sound every time from the intensity of the sound generated when the workpiece 60 is cut by the cutting machine 10 acquired in step S100. Thereby, the abnormality detection device 30 removes the environmental sound from the sound generated when the workpiece 60 is cut by the cutting machine 10 so as to remove noise included in the sound generated when the workpiece 60 is cut by the cutting machine 10.

In step S102 following step S140, the abnormality detection device 30 performs short-time Fourier transform on the intensity component of the time waveform calculated in step S140. Thereby, the abnormality detection device 30 acquires a frequency characteristic indicating the relationship between frequency and intensity. Further, the abnormality detection device 30 calculates an area Sr surrounded by a line indicating the relationship between the frequency in the predetermined range of the acquired frequency characteristic and its intensity. Subsequently, in steps S104 to S124, the abnormality detection device 30 performs the same processings as in the first embodiment.

As described above, the abnormality detection device 30 of the seventh embodiment performs the processings. The seventh embodiment achieves effects similar to the effects achieved by the first embodiment. Furthermore, the seventh embodiment also achieves the effects described below.

[5] The abnormality detection device 30 acquires frequency components of sounds detected by the plurality of sensors 20. As a result, the plurality of sensors 20 collect different sounds, so that the abnormality detection device 30 can acquire the sound generated when the workpiece 60 is cut by the cutting machine 10 and the frequency components of the noise included in the sound. Therefore, since the noise included in the sound generated when the workpiece 60 is cut by the cutting machine 10 can be removed, the S/N ratio of the sound generated when the workpiece 60 is cut by the cutting machine 10 is improved.

### Eighth Embodiment

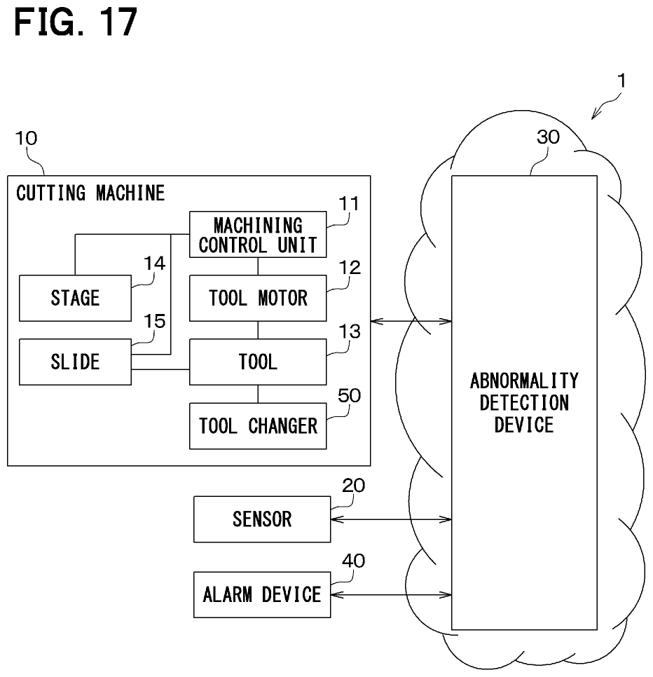

In the eighth embodiment, as shown in FIG. 17, the abnormality detection device 30 is connected to a network such as the Internet. Further, the cutting machine 10, the sensor 20, and the alarm device 40 have a communication section (not shown) that communicates with the abnormality detection device 30 via this network. Further, the abnormality detection device 30 activates the cutting machine 10, the sensor 20, and the alarm device 40 by communicating with the cutting machine 10, the sensor 20, and the alarm device 40 via the network. Further, the abnormality detection device 30 communicates with the cutting machine 10, the sensor 20, and the alarm device 40 via the network, thereby acquiring the information about the cutting machine 10, the sensor 20, and the alarm device 40 from the cutting machine 10, the sensor 20, and the alarm device 40. The other configurations are similar to those of the first embodiment. This eighth embodiment also achieves the same effects as the first embodiment. Furthermore, the eighth embodiment also achieves the effects described below.

The abnormality detection device 30 is connected to the network and communicates with the cutting machine 10 via the network. Therefore, services, ie, cloud services, can be provided to users via the network. Thereby, for example, when a plurality of abnormality detection devices 30 are used, it is not necessary for each of the abnormality detection devices 30 to have a program for making the abnormality detection device 30 function, so that the cost of the abnormality detection devices 30 can be reduced. Further, information for making the abnormality detection device 30 function can be unitary managed. Therefore, for example, when a plurality of abnormality detection devices 30 are used in a factory or the like, it becomes easier to manage the plurality of abnormality detection devices 30, leading to improved productivity in the factory.

### Ninth Embodiment

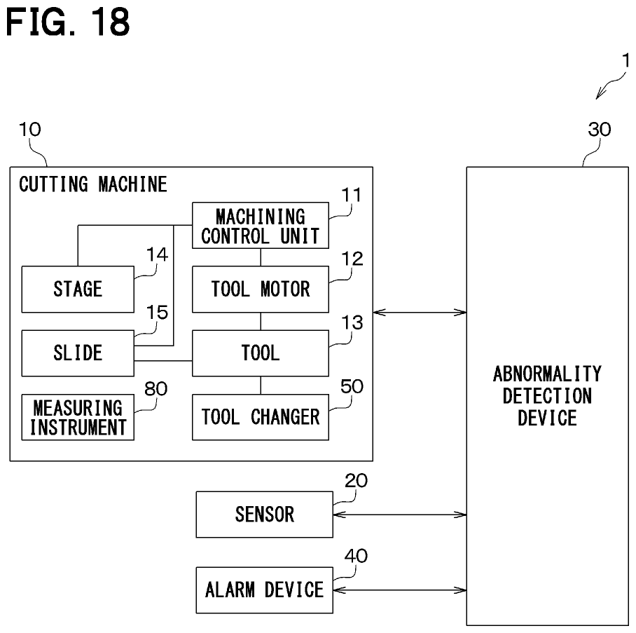

In the ninth embodiment, as shown in FIG. 18, the cutting machine 10 has a measuring instrument 80 in addition to the machining control unit 11, the tool motor 12, the tool 13, the stage 14, the slide 15, and the tool changer 50. Further, the processings of the abnormality detection device 30 are different from the first embodiment. The other configurations are similar to those of the first embodiment.

The measuring instrument 80 is, for example, a laser measuring instrument or an image measuring instrument, and measures a shape of the tool 13 using light based on a signal from the abnormality detection device 30.

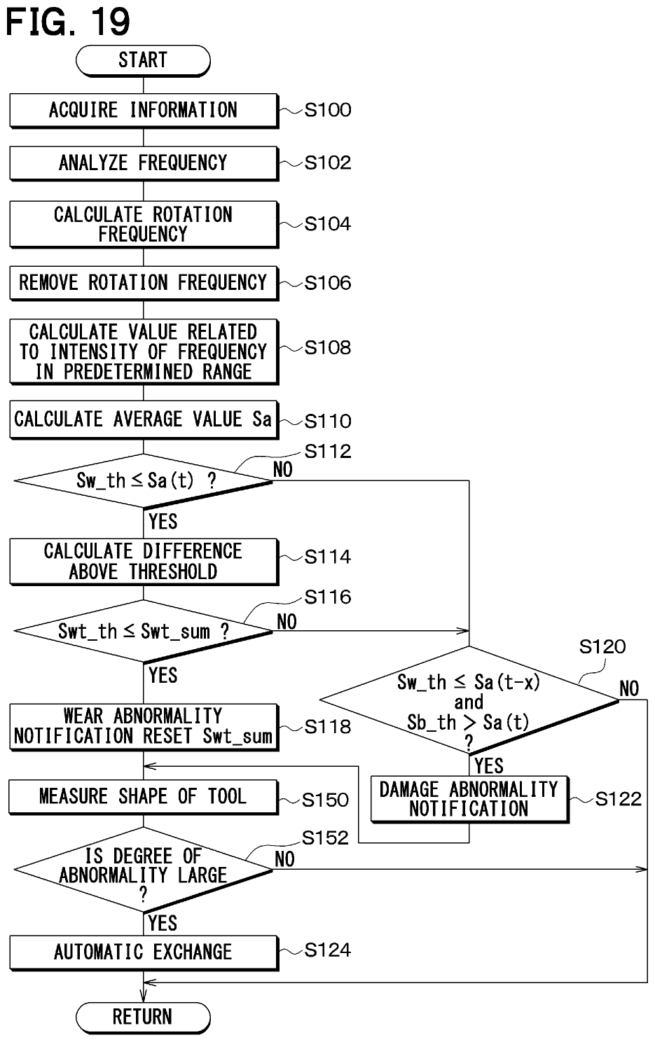

Next, the processing of the abnormality detection device 30 will be explained with reference to the flowchart of FIG. 19. In steps S100 to S122, the abnormality detection device 30 performs the same processings as in the first embodiment.

After processing either step S118 or step S122, in step S150, the abnormality detection device 30 outputs a signal for measuring the shape of the tool 13 to the measuring instrument 80. Thereby, the measuring instrument 80 measures the shape of the tool 13. Further, the abnormality detection device 30 acquires information regarding the shape of the tool 13 measured by the measuring instrument 80 from the measuring instrument 80.

Subsequently, in step S152, the abnormality detection device 30 compares the shape of the tool 13 in the current control cycle τ(t) acquired in step S150 with the shape of the tool 13 in the previous control cycle τ(t−1). Thereby, the abnormality detection device 30 determines whether the degree of abnormality of the tool 13 is large. The degree of abnormality of the tool 13 is, for example, a change in dimensions or a change in shape of the tool 13.

For example, the abnormality detection device 30 calculates the amount of change in the size of the tool 13 by calculating the absolute value of the difference between the size of the tool 13 in the current control cycle τ(t) and the size of the tool 13 in the previous control cycle τ(t−1), Furthermore, when the calculated amount of change is greater than or equal to the change amount threshold, the abnormality detection device 30 determines that the degree of abnormality of the tool 13 is large because the change in the size of the tool 13 is large. Thereafter, the processing of the abnormality detection device 30 moves to step S124. Further, when the calculated change amount is less than the change amount threshold, the abnormality detection device 30 determines that the degree of abnormality of the tool 13 is small because the change in the size of the tool 13 is small. Thereafter, the processing of the abnormality detection device 30 returns to step S100. The change amount threshold is set by experiment, simulation, etc. so that the magnitude of the change in shape of the tool 13 is determined by the abnormality detection device 30. Further, the change amount threshold may be freely set by the user of the abnormality detection device 30.

As described above, the abnormality detection device 30 of the ninth embodiment performs the processings. The ninth embodiment achieves effects similar to the effects achieved by the first embodiment. Furthermore, the ninth embodiment also achieves the effects described below.

[6] The abnormality detection device 30 serves as a measuring section that causes the measuring instrument 80 to measure the shape of the tool 13 when it is determined in step S150 that the cutting machine 10 is abnormal. Further, the abnormality detection device 30 plays a role as a degree calculation section that calculates the degree of abnormality of the tool 13 by calculating the shape change of the tool 13 in step S152.

As a result, in addition to determining an abnormality due to wear or breakage of the tool 13 from the sound generated by cutting with the cutting machine 10, it is also possible to determine an abnormality due to wear or breakage of the tool 13 from changes in the shape of the tool 13. Therefore, the incorrect determination of abnormality due to wear or damage of the tool 13 is suppressed. Further, the measuring instrument 80 measures the shape of the tool 13 using light. Thereby, since the shape of the tool 13 is measured without contact, the influence on the degree of abnormality of the tool 13 is suppressed. Therefore, since the accuracy of the degree of abnormality of the tool 13 is improved, the incorrect determination of abnormality due to wear or damage of the tool 13 is suppressed.

### Other Embodiments

The present disclosure is not limited to the above-described embodiments, and the above-described embodiments can be appropriately modified. The constituent element(s) of each of the above embodiments is/are not necessarily essential unless it is specifically stated that the constituent element(s) is/are essential in the above embodiment, or unless the constituent element(s) is/are obviously essential in principle.

The analysis section, the calculation section, the determination section, the notification section, the exchange section and methods thereof described in the present disclosure may be realized by a dedicated computer provided by configuring a processor, programmed to execute one or more functions embodied by a computer program, and a memory. Alternatively, the analysis section, the calculation section, the determination section, the notification section, the exchange section and methods thereof described in the present disclosure may be realized by a dedicated computer provided by configuring a processor with one or more dedicated hardware logic circuits. Alternatively, the analysis section, the calculation section, the determination section, the notification section, the exchange section and methods thereof described in the present disclosure may be realized by one or more dedicated computers configured by a combination of a processor programmed to execute one or more functions, a memory, and a processor configured by one or more hardware logic circuits. The computer programs may be stored, as instructions to be executed by a computer, in a tangible non-transitory computer-readable medium.

In each of the embodiments described above, the cutting machine 10 performs drilling in the workpiece 60 as cutting. On the other hand, cutting by the cutting machine 10 is not limited to drilling holes in the workpiece 60. The cutting performed by the cutting machine 10 may include lathing, boring, milling, planing, shaping, or the like.

In each of the embodiments described above, the sensor 20 detects the sound generated by cutting by the cutting machine 10 as a physical quantity. On the other hand, the sensor 20 is not limited to detecting the sound generated by cutting by the cutting machine 10 as a physical quantity. For example, the sensor 20 may include a piezoelectric element or the like to detect the acceleration or vibration of the tool 13 generated by cutting by the cutting machine 10 as a physical quantity. In this case, the abnormality detection device 30 performs a series of processings from step S100 to step S124 using the frequency component of acceleration or vibration corresponding to the electrical signal from the sensor 20. Thereby, the abnormality detection device 30 detects an abnormality due to wear or breakage of the tool 13, similarly to each of the above embodiments. Also in this case, as in each of the embodiments described above, the incorrect determination of abnormality due to wear or damage of the tool 13 is suppressed.

In each of the embodiments described above, the damage threshold Sb_th is smaller than the wear threshold Sw_th. On the other hand, the damage threshold Sb_th is not limited to being smaller than the wear threshold Sw_th. Since the state of wear and damage of the tool 13 differs depending on the configuration of the abnormality detection system 1, the damage threshold Sb_th may be equal to or greater than the wear threshold Sw_th.

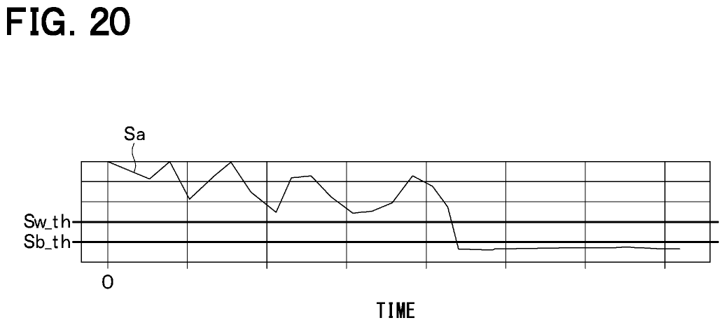

In each of the embodiments described above, in step S110, the abnormality detection device 30 calculates the smoothed value Sa with respect to time in the average value Ss calculated in step S108. On the other hand, the abnormality detection device 30 may calculate the smoothed value Sa by detecting an envelope curve, for example, as shown in FIG. 20.

In each of the above embodiments, the abnormality detection device 30 calculates the difference Swt that exceeds the wear threshold value Sw_th out of the smoothed value Sa and the difference sum Swt_sum in step S114. On the other hand, the abnormality detection device 30 is not limited to calculating the difference Swt and the difference sum Swt_sum in step S114. For example, the abnormality detection device 30 multiplies the smoothed value Sa calculated in step S110 by the control period τ. Thereby, the abnormality detection device 30 calculates an area surrounded by the line indicating the relationship between the smoothed value Sa and time when the smoothed value Sa is equal to or greater than the wear threshold value Sw_th. Further, the abnormality detection device 30 calculates the sum of the calculated areas. Then, the abnormality detection device 30 may determine that the cutting accuracy has decreased due to wear of the tool 13, using the calculated area sum and the threshold value. In this case, the sum of areas corresponds to an integrated value of intensity-related values corresponding to frequencies in the predetermined range.

In each of the embodiments described above, the stage 14 moves the workpiece 60 in one direction perpendicular to the axis of the tool 13 and in a direction perpendicular to the one direction. On the other hand, the stage 14 may move the workpiece 60 in the axial direction of the tool 13 in addition to moving the workpiece 60 in one direction perpendicular to the axis of the tool 13 and in a direction perpendicular to the one direction.

In each of the embodiments described above, the slide 15 moves the tool 13 in the axial direction. On the other hand, in addition to moving the tool 13 in the axial direction, the slide 15 may be moved in one direction perpendicular to the axis of the tool 13 and in a direction perpendicular to that one direction.

The above-described embodiments may be combined as appropriate.

What is claimed is:

1. An abnormality detection device, comprising:
an analysis section configured to acquire a frequency component of physical quantity generated by working by a machine;
a calculation section configured to calculate a value obtained by smoothing a value related to an intensity corresponding to a frequency in a predetermined range including a frequency at which wear occurs due to working of the machine in the frequency component; and
a determination section configured to determine that the machine is abnormal when the value smoothed by the calculation section is outside a range between a damage threshold and a wear threshold.

2. The abnormality detection device according to claim 1, wherein
the value related to the intensity corresponding to the frequency in the predetermined range is a value obtained by subtracting the value related to the intensity corresponding to the frequency included in the predetermined range among the frequencies caused by a rotation of a tool of the machine from the value related to the intensity corresponding to the frequency in the predetermined range, and
the calculation section calculates a value obtained by smoothing the subtracted value.

3. The abnormality detection device according to claim 1, wherein
the value related to the intensity corresponding to the frequency in the predetermined range is a value obtained by subtracting the value related to the intensity corresponding to the frequency included in the predetermined range among the frequencies of the physical quantity that occurs when the machine idles from the value related to the intensity corresponding to the frequency in the predetermined range,
the calculation section calculates a value obtained by smoothing the subtracted value.

4. The abnormality detection device according to claim 1, wherein
the calculation section calculates a peak value that is larger than a peak value related to wear due to working of the machine that is included in the frequency in the predetermined range.

5. The abnormality detection device according to claim 1, wherein
the determination section determines that the tool of the machine is abnormal due to wear when the value smoothed by the calculation section is equal to or greater than the wear threshold.

6. The abnormality detection device according to claim 1, wherein
the damage threshold is smaller than the wear threshold, and
the determination section determines that a tool of the machine is damaged when the value smoothed by the calculation section changes from equal to or higher than the wear threshold to lower than the damage threshold.

7. The abnormality detection device according to claim 5, wherein
the determination section determines that the tool is abnormal due to wear when an integrated value of the values smoothed by the calculation section is equal to or greater than a threshold value.

8. The abnormality detection device according to claim 1, wherein
the analysis section acquires a frequency component of the physical quantity detected by a plurality of sensors.

9. The abnormality detection device according to claim 1, wherein
the abnormality detection device is connected to a network and communicates with the machine via the network.

10. The abnormality detection device according to claim 1, further comprising:
a notification section that causes an alarm device to notify that the machine is abnormal when the determination section determines that the machine is abnormal.

11. The abnormality detection device according to claim 1, further comprising:
an exchange section that causes a tool changer to automatically exchange the tool of the machine when the determination section determines that the machine is abnormal.

12. The abnormality detection device according to claim 1, further comprising:
a measuring section that causes a measuring instrument that measures a shape of a tool of the machine to measure the shape of the tool, when the determination section determines that the machine is abnormal, and
a degree calculation section that calculates a degree of abnormality of the tool by calculating a change in shape of the tool.

13. An abnormality detection system, comprising:
a sensor configured to detect a physical quantity generated by working by a machine;
an abnormality detection device including
an analysis section configured to acquire a frequency component of the physical quantity,
a calculation section configured to calculate a value obtained by smoothing a value related to an intensity corresponding to a frequency in a predetermined range including a frequency at which wear occurs due to working of the machine in the frequency component, and
a determination section configured to determine that the machine is abnormal when the value smoothed by the calculation section is outside a range between a damage threshold and a wear threshold.

14. A method for detecting an abnormality, comprising:
acquiring a frequency component of physical quantity generated by working by a machine;
calculating a value obtained by smoothing a value related to an intensity corresponding to a frequency in a predetermined range including a frequency at which wear occurs due to working of the machine in the frequency component; and
determining that the machine is abnormal when the smoothed value is outside a range between a damage threshold and a wear threshold.

15. A computer readable medium, comprising:
an abnormality detection program configured to cause an abnormality detection device to function as
an analysis section configured to acquire a frequency component of physical quantity generated by working by a machine;
a calculation section configured to calculate a value obtained by smoothing a value related to an intensity corresponding to a frequency in a predetermined range including a frequency at which wear occurs due to working of the machine in the frequency component, and
a determination section configured to determine that the machine is abnormal when the value smoothed by the calculation section is outside a range between a damage threshold and a wear threshold.
